(19) United States
(12) Patent Application Publication
(10) Pub. No.: US 2007/0256898 A1
(43) Pub. Date: Nov. 8, 2007

(54) Drive Systems

(76) Inventor: Martin Adrian Lee, Hampshire (GB)

Correspondence Address: STITES & HARBISON PLLC, 424 CHURCH STREET, SUITE 1800, NASHVILLE, TN, 37219-2376, US

(21) Appl. No.: 10/583,909

(22) PCT Filed: Dec. 17, 2004
(86) PCT No.: PCT/GB04/05295

§ 371 Date: Mar. 23, 2007

(30) Foreign Application Priority Data
Dec. 20, 2003 (GB) 0329785.0

(51) Int. Cl. B66B 9/04

(52) U.S. Cl. 187/275

(57) ABSTRACT

A hydraulically driven elevator or lift is provided with counterbalance means to at least partly counterbalance the load imposed by the load carrier or lift car. Operation of the counterbalance means, which includes a substantially constant volume of pressurised fluid, does not involve any interference with the working fluid of the hydraulic drive system.

### FIELD OF THE INVENTION

This invention relates to drive systems. The system described herein has been developed for particular application to hydraulically powered elevators, lifts or lifting platforms but it will be appreciated that a drive system as disclosed herein could have application in a variety of alternative fields.

In the following specification the terms ‘elevator’, ‘lift’ and lifting platform are used inter-changeably and are intended to have the same meanings.

### BACKGROUND TO THE INVENTION

In typical hydraulic powered elevators or lifts, the combination of the weight of the moving equipment or lift car, and the load carried thereby, is lifted by the effect of fluid displaced by a hydraulic pump unit. The operation of the hydraulic pump generates considerable heat which, in the confined space of a lift well or lift machine room, can be difficult to dissipate. In any event, the heat generated represents lost energy and less than optimum efficiency.

Various attempts have been made, in the past, to reduce the power requirement, and thus the heat generation.

One method adopted in the past, is the use of a mechanical counterweight. The disadvantage of a mechanical counterweight is that it requires its own set of vertical guide rails. This adds both to material costs and installation times.

More recently, hydraulic lift installations have been provided with one or more separate hydraulic accumulators into which hydraulic fluid is displaced as the lift car moves downwards. Typically, within the accumulator is a membrane which separates the incoming fluid from a chamber of compressed gas. The incoming fluid further compresses the gas. When the lift car is called to rise, the fluid within the accumulator is released and the gas within the accumulator helps expel the fluid and thus displace the lift car upwardly. Examples of lift accumulators can be found in International (PCT) Patent Application Nos. WO 99/33740 and WO 01/14238.

A variation of the accumulator-equipped devices described above, using a spring in place of the chamber of pressurised gas, is described in German offenlegungsschrift 32 06 899.

Whilst accumulators do assist in reducing the power requirement to raise the lift car and load, the working fluid itself is directed into the accumulator and, thus, is still subject to the total weight of the lift car and load. Further, there is added cost in providing the accumulator and associated pipe work and instances have been reported of accumulators causing the lift car to rise unintentionally when there has been a failure of one or more of the control valves.

Yet a further form of accumulator-equipped lift is described in published Japanese (JP) Application 2002-372008. This publication describes a lift powered by a hydraulic ram in which the accumulator is integral with the ram. A separate accumulator chamber is provided centrally within the cylinder of the ram and this chamber sealingly communicates with a hollow piston tube. The hollow piston tube and the accumulator are filled with pressurised gas. The pressurised hydraulic fluid, which powers the lift, is provided in an annulus about the piston gas chamber. It will be appreciated that the pressurised gas within the centre of the ram serves to offset the effect of a load applied to the lift.

The device described in JP 2002-372008 has it own drawbacks. The principal drawback is that the volume of the pressurised gas chamber varies considerably as the lift ram extends and the pressure of the gas drops as a consequence. Accordingly, the counterweight effect when the lift is at the top of its travel will be considerably less than when the lift is at the bottom of its travel. It is an object of this invention to provide a method of, and means for reducing the power requirement of a hydraulic lift which will go at least some way in addressing the problems outlined above; or which will at least provide a novel and useful choice.

### SUMMARY OF THE INVENTION

Accordingly, in a first aspect, the invention provides a lift including a load carrier;

an hydraulic ram operable to displace said load carrier in a substantially vertical direction; and

a counterbalance operable to reduce the load imposed by said load carrier on said hydraulic ram,

said lift being characterised in that said counterbalance includes a chamber of substantially constant volume housing a pressurised fluid.

Preferably said counterbalance is a stroke-based device as herein defined.

Preferably said counterbalance is formed in unit with said hydraulic ram.

Preferably said counterbalance is defined, in part, by an annular chamber provided about said hydraulic ram.

Preferably said counterbalance further includes an annular slider having an upper surface and a lower surface, said slider being displaceable within said annular chamber with movement of said hydraulic ram, wherein said slider has axial ports therein linking said upper surface to said lower surface, and wherein the area of said lower surface is greater than the area of said upper surface.

Preferably said pressurised fluid comprises a pressurised gas.

Preferably said pressurised gas comprises nitrogen.

Preferably said counterbalance is constructed and arranged to provide a counterbalance effect of less than the weight of said load carrier.

Preferably said counterbalance is configured to provide a counterbalance effect of 70 to 90% of the weight of said load carrier.

In a second aspect, the invention provides a drive unit for a hydraulic lift, said drive unit including an hydraulic ram having a cylinder and a piston extendible and retractable with respect to said cylinder, said unit being characterised in that it further includes a counterbalance integral with said hydraulic ram, said counterbalance including a chamber of substantially constant volume housing a pressurised fluid.

Preferably said chamber of substantially constant volume is annular in form and arranged about the axis of said cylinder.

Preferably said chamber is defined, in part, by said piston and by said cylinder.

Preferably said pressurised fluid comprises a pressurised gas.

In a third aspect, the invention provides a method of reducing the power requirement of an hydraulic lift which includes a load carrier and an hydraulic ram operable to displace said load carrier in a substantially vertical direction,

said method including positioning a counterbalance so as to reduce the load imposed by said load carrier on said hydraulic ram, said counterbalance including a chamber of substantially constant volume housing a pressurised fluid.

Preferably said method further includes providing said counterbalance in unit with said hydraulic ram.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future. The scope of the invention should be limited by the appended claims alone.

### BRIEF DESCRIPTION OF THE DRAWINGS

One operating embodiment of the invention will now be described with reference to the accompanying drawings in which:

FIG. 1: shows an elevational diagrammatic view of a hydraulic lift to which the various aspects of the invention may be applied;

FIG. 2: shows a diagrammatic view of a prior art accumulator system for reducing the power requirement of a hydraulic lift;

FIG. 3: shows a diagrammatic view of a lift with reduced power requirement embodying the broad principles of the invention;

FIG. 4: shows a cross-sectional view of operating means according to the invention in a fully retracted state; and

FIG. 5: shows a view similar to FIG. 4 but with the operating means in a partially extended state.

### DETAILED DESCRIPTION OF WORKING EMBODIMENT

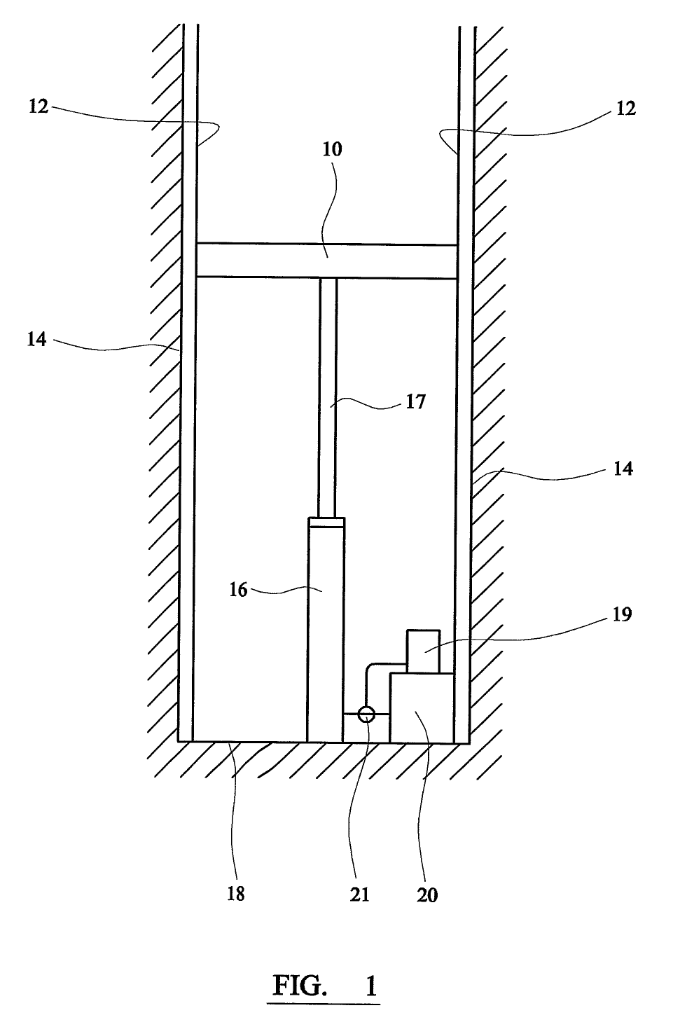

Referring firstly to FIG. 1, a typical hydraulic lift installation comprises a load carrier in the form of lift car or platform 10 supported on lift guides 12, the guides 12 being fixed to, and extending vertically upwards, in a lift shaft 14. A hydraulic ram 16, having a moving piston 17, is mounted on the base 18 of the lift shaft, the piston 17 engaging the underside of the lift car 10 so as to displace the lift car upwards and downwards in the lift shaft 14.

In order to extend piston 17 from the cylinder of ram 16, hydraulic fluid is pumped by motor/pump unit 19 drawing fluid from reservoir 20. When the lift car is required to move in the downwards direction, dump valve 21 is opened to allow the hydraulic fluid to pass directly back into the reservoir 20. Alternatively, the motor/pump unit is reversed to scavenge fluid from the cylinder and return the same to the reservoir 20.

In the particular embodiment shown in FIG. 1, the piston 17 bears directly against the lift car 10 however, as is well known in the art, the piston may displace a roping arrangement which results in the displacement of the lift car 10 with respect to the displacement of the piston 17, being multiplied. Whilst such roping per se does not form part of this invention it can be used to advantage to increase system pressure and, thereby, allow the use of lower fluid volumes.

Indeed all that has been described above is entirely conventional as are variations thereof. For example, it is common to immerse the motor pump unit 19 within the fluid contained in reservoir 20.

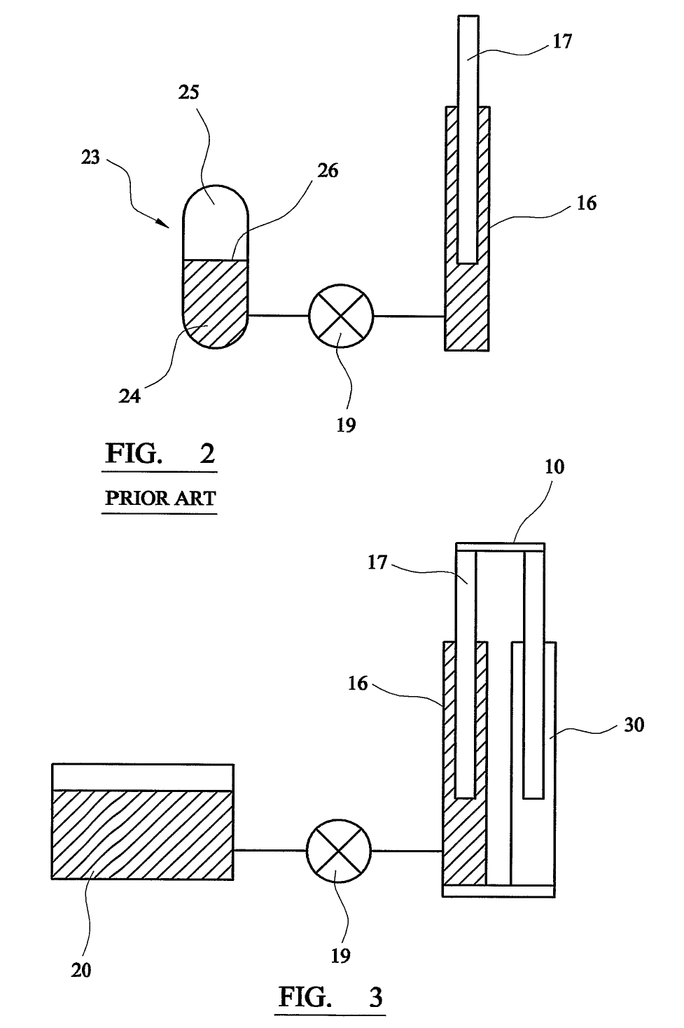

In the past various means have been implemented to reduce the load on the hydraulic system and, thereby, reduce the overall power requirement. The most conventional means comprises a simple mechanical counterweight mounted so as to apply a displacement force to the lift car in a direction opposite to that applied to the lift car by the piston 17. As described above, a mechanical counterweight requires its own guide rails and roping arrangement and is thus relatively expensive to implement. It can also occupy significant space in the lift shaft. Thus, attention has been diverted to the hydraulic drive system itself in the search for a more efficient overall drive system. Referring now to FIG. 2, one known system for harnessing energy in a hydraulic lift installation involves the use of an hydraulic accumulator. In the manner described above, piston 17 is displaced to raise the lift car (not shown) by operation of hydraulic motor/pump 19. When the lift car is to descend, instead of the fluid in ram 16 being pumped or dumped back into the reservoir 20 as described above, it is pumped into the lower chamber 24 of an accumulator 23. The accumulator 23 also includes an upper, gas-filled chamber 25, the chambers 24 and 25 being separated by a movable or flexible membrane 26.

When the lift car is next required to rise, a demand is placed on the fluid in chamber 24 of the accumulator, whereupon the compressed gas in chamber 25 expands and drives the fluid from chamber 24. It will be appreciated that this action positively assists the pump motor/pump unit 19.

Turning now to FIG. 3, the drive element principles of a lift drive system according to the invention are entirely conventional and, as illustrated, include a hydraulic ram 16 having a piston 17 extendible there-from and retractable therein. Hydraulic fluid from reservoir 20 is, in the conventional manner, pumped by motor/pump 19 into the cylinder 16 to raise lift car 10. When the lift car is to descend, the motor/pump is reversed, or suitable valving (not shown) is operated, to cause the fluid in cylinder 16 to return to the reservoir 20.

The novelty in the present invention resides in providing one or more devices 30 which at least partially counterbalance the downward load imposed by the lift car 10. Whilst device 30 may be in close physical proximity to hydraulic drive components, it operates entirely independently of the drive system, in that the device 30 does not receive any fluid from reservoir 20. The device 30 is preferably a stroke-based counterbalance device. That is to say, a device which operates along a substantially linear axis and generates a supporting function in at least one direction of movement. A typical example of a stroke-based counterbalance device comprises a gas strut.

As can be seen, the counterbalance device 30 is preferably positioned so that the operating axis thereof is substantially parallel to the operating axis of the hydraulic drive. In effect the device 30 comprises a form of counterweight and, as such, reduces the load imposed on the hydraulic drive system by the lift car 10.

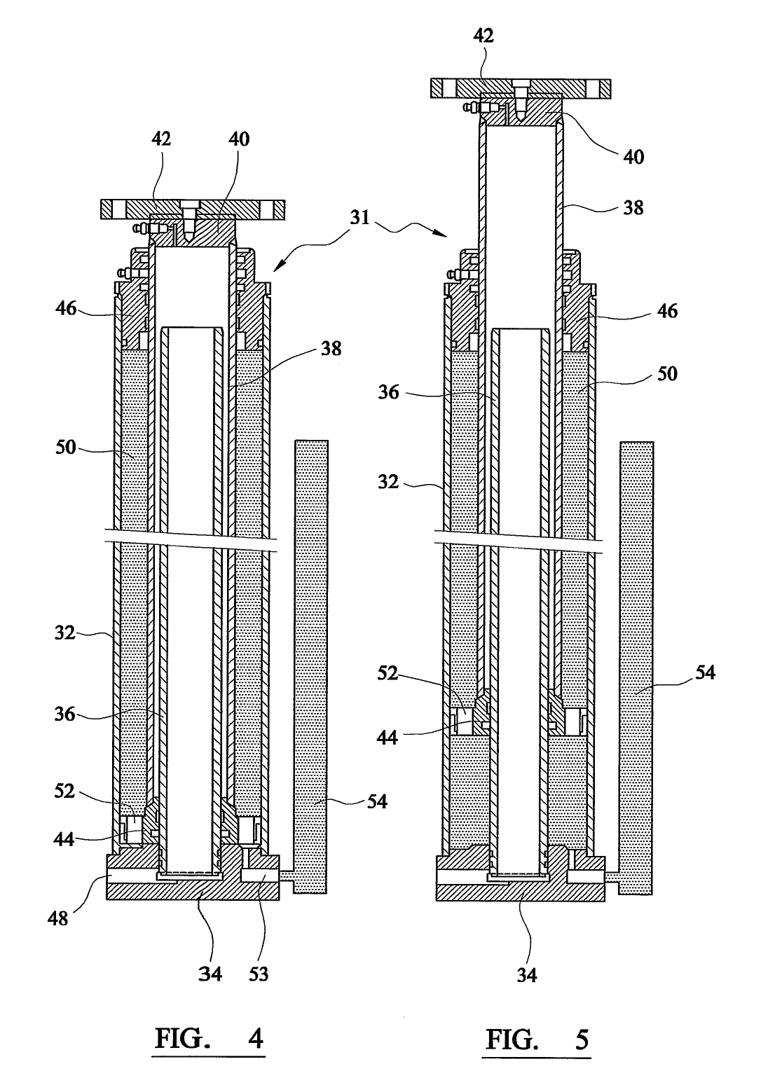

Turning now to FIGS. 4 and 5, the counterbalance device may be provided in unit with the hydraulic drive system. In such an arrangement, it is most convenient to apply the counterbalance force along the same axis as the drive force.

In the form shown, drive unit 31 comprises an outer cylinder body 32 which is fixed to base member 34. Fixed to the inner surface of base 34 is a static drive cylinder 36, the drive cylinder 36 being located centrally within outer body 32. Located over the drive cylinder 36, and in sliding contact therewith, is a piston cylinder 38, the upper end of which is capped by a piston 40. Mounting flange 42, by means of which the drive unit is attached to the lift car 10, is attached to, or formed integrally with, the piston 40. It will be noted that, unlike the piston rod of a conventional hydraulic ram, piston cylinder 38 is hollow, its interior is in communication with cylinder 36, and is filled with oil. This is believed to have an advantage in the reduction of the buckling loads to which the unit 31 is subjected.

It will be appreciated that the fluid in the interior of drive cylinder 36 is essentially ‘dead’ fluid and accordingly, the volume of the drive cylinder (and thus the volume of working fluid) may be reduced by inserting a filler rod or the like (not shown) within the drive cylinder 36.

The outer lower end of piston cylinder 38 carries a further piston or annular slider 44 which slides over, but seals against, the outer surface of the drive cylinder 36. The piston cylinder is further supported by upper seal 46, the seal 46 being fixed to outer cylinder 32 but forming a sliding seal against the outer surface of piston cylinder 38.

To drive the lift car 10 in an upwards direction, hydraulic fluid is fed under pressure, through port 48, in base member 34. Port 48 communicates with the interior of drive cylinder 36 and, in turn, with the interior of piston cylinder 38. Thus the incoming fluid acts against piston 40 and causes the piston cylinder 38 to telescope upwardly over the drive cylinder 36. When the lift car is to move in a downwards direction, the port 48 is placed in communication with a low pressure reservoir and the fluid within the interior of the cylinders 36 and 38 pumped or allowed to bleed there-from.

It will be appreciated that an annular chamber 50 is defined between the inner surface of the outer body 32 and the outer surfaces of the drive and piston cylinders 36 and 38 respectively. This chamber is used to provide the counterbalance force discussed above. Whilst some form of mechanical contrivance could be fitted within the chamber, for example a coil spring acting between the base 34 and the slider 44, the chamber 50 is preferably charged with compressed gas or liquid so that a fluid strut is formed about the hydraulic drive.

As can be seen, the slider 44 not only provides a sliding seal between the cylinder 38 and the cylinder 36, but also extends across annulus 50 to provide a sliding contact against the inner surface of cylindrical body 32. Axial ports 52 are provided in the seal 44 to allow the sections of the chamber 50, above and below the slider 44, to communicate with one another, and thus the fluid pressures in the two chamber parts, to balance.

The chamber 50 is charged with compressed gas through port 53 in the base 34. Once the chamber 50 is charged with the required amount of gas, the port 53 may be sealed off. However, to provide a greater volume of available gas, and to reduce the difference in pressure between when the ram is extended and when the ram is retracted, it is preferable to provide an external gas chamber 54 which is placed in communication with the port 53.

The configuration of the components ensures that the compressed gas within chamber 50 provides an upward component of force on the annular slider 44 and thus counterbalance, at least to some extent, the downward component of force imposed by the lift car 10 and any load carried thereby. More particularly, in the embodiment depicted and described, the lower surface of the annular slider 44 presents a greater surface area to the compressed fluid, than does the upper surface.

Chamber 50 is preferably charged with gaseous nitrogen as nitrogen is substantially inert. It will be appreciated, however, that other gases and fluids could be used without departing from the scope of the invention.

It is to be noted that, because of the provision of axial ports 52, the combined volumes of chambers 50 and 54 are substantially constant though there is some small variation due to the difference between the width of the annulus above and below the slider 44. As a consequence the pressure of the fluid within the chambers remains substantially constant throughout the travel of the lift car, and thus the counterbalance effect also remains substantially constant throughout the travel of the lift car.

It will also be appreciated that the fluid within chambers 50 and 54 is entirely independent of that within the drive cylinder 36 and piston 38.

To configure a drive system as described above, the empty load of the lift car 10 is calculated and the number of counterbalances, the geometry thereof, and the gas pressures therein, determined so as to ensure the lift car 10 always imposes a small net downward force. In reality it is preferred that the counterbalance is no more than 90% of the weight of the empty lift car and, more preferably, in the range of 70 to 90% of the weight of the lift car. This ensures the lift car is able to descend under manual lowering and avoids the chance of the lift car rising under the effect of the counterbalance alone.

By way of example only, a lift and lift drive system could have the following nominal configuration:

| | | |
|---|---|---|
| Weight of lift car | 800 | kg |
| Rated load | 630 | kg |
| Required counter balance (90% of lift car) | 720 | kg |
| Inside diameter of cylinder 32 | 114 | mm |
| Outer diameter of cylinder 38 | 68 | mm |
| Hydraulic working pressure | 115 | bar |
| Gas pressure in chamber 50 | 103 | bar |
| Hydraulic tank capacity | 40 | litres |

The above specification enables a lift of the cited weight to be operated at a nominal speed of 0.63 m/s using a motor rated at 7.5 KW.

The lift drive system as above described is believed to have the following advantages:

1) Because a substantial part of the operating mass of the lift is counterbalanced, effective lift operation can be achieved using a relatively small hydraulic package.

2) The system requires a relatively small volume of hydraulic oil to operate.

3) The provision of a fluid-based counterbalance system which is both independent of the drive fluid, and which is substantially constant in volume, ensure a substantially constant counterbalance force throughout the lift travel.

4) Because of the low loading imposed on the hydraulic drive, heat and noise generation is low.

5) The hollow piston rod in communication with the interior of the cylinder reduces buckling for a given load.

Many variations to the system above described will present themselves to those skilled in the art. For example, as stated above, the invention may be applied to lifting or support systems other than lifts or elevators and may be incorporated in other lifting systems.

It will thus be appreciated that the invention, at least in the case of the working embodiment herein described, provides a novel and effective means of reducing the power requirement of an hydraulic lift which requires no specialist fitting requirements and is independent of the lift drive system.

1. A lift including a load carrier;
a hydraulic ram operable to displace said load carrier in a substantially vertical direction; and
a counterbalance operable to reduce the load imposed by said load carrier on said hydraulic ram,
said lift being characterized in that said counterbalance includes a chamber of substantially constant volume housing a pressurized fluid.

2. A lift as claimed in claim 1 wherein said counterbalance is stroke-based.

3. A lift as claimed in claim 1 wherein said counterbalance is formed in unit with said hydraulic ram.

4. A lift as claimed in claim 3 wherein said counterbalance includes an annular chamber provided about said hydraulic ram.

5. A lift as claimed in claim 4 wherein said counterbalance further includes an annular slider having an upper surface and a lower surface, said slider being displaceable within said annular chamber with movement of said hydraulic ram, wherein said slider has axial ports therein linking said upper surface to said lower surface, and wherein the area of said lower surface is greater than the area of said upper surface.

6. A lift as claimed in claim 1 wherein said pressurized fluid comprises a pressurized gas.

7. A lift as claimed in claim 6 wherein said pressurized gas comprises nitrogen.

8. A lift as claimed in claim 1 wherein said counterbalance is constructed and arranged to provide a counterbalance effect of less than the weight of said load carrier.

9. A lift as claimed in claim 8 wherein said counterbalance is configured to provide a counterbalance effect of 70 to 90% of the weight of said load carrier.

10. A drive unit for hydraulic lift, said drive unit including an hydraulic ram having a cylinder and a piston extendible and retractable with respect to said cylinder, said unit being characterized in that it further includes a counterbalance integral with said hydraulic ram, said counterbalance including a chamber of substantially constant volume housing a pressurized fluid.

11. A drive unit as claimed in claim 10 wherein said chamber of substantially constant volume is annular in form and arranged about the axis of said cylinder.

12. A drive unit as claimed in claim 11 wherein said chamber is defined, in part, by said piston and by said cylinder.

13. A drive unit as claimed in claim 10 wherein said pressurized fluid comprises a pressurized gas.

14. A method of reducing the power requirement of an hydraulic lift which includes a load carrier and an hydraulic ram operable to displace said load carrier in a substantially vertical direction,
said method including positioning a counterbalance so as to reduce the load imposed by said load carrier on said hydraulic ram, said counterbalance including a chamber of substantially constant volume housing a pressurized fluid.

15. A method as claimed in claim 14 further including providing said counterbalance in unit with said hydraulic ram.
